(19) United States
(12) Patent Application Publication
(10) Pub. No.: US 2026/0148391 A1
(43) Pub. Date: May 28, 2026

(54) DATA PROCESSING METHOD, ELECTRONIC DEVICE, AND STORAGE MEDIUM

(71) Applicant: Shining 3D Tech Co., Ltd., Hangzhou (CN)

(72) Inventors: Xiaopeng Fu, Hangzhou (CN); Xiaobo Zhao, Hangzhou (CN); Xiaojun Chen, Hangzhou (CN); Chao Ma, Hangzhou (CN)

(21) Appl. No.: 19/453,196

(22) Filed: Jan. 20, 2026

Related U.S. Application Data
(63) Continuation-in-part of application No. PCT/CN2024/109629, filed on Aug. 2, 2024.

(30) Foreign Application Priority Data
Aug. 2, 2023 (CN) 202310969399.3

(51) Int. Cl. G06T 7/246; G06T 7/00

(52) U.S. Cl. CPC G06T 7/246; G06T 7/0012; G06T 2207/30036; G06T 2207/30201; G06T 2207/30204; G06T 2207/30241

(57) ABSTRACT

The present disclosure relates to a data processing method, an electronic device, and a storage medium. The method includes: acquiring a plurality of closing motion trajectories of a mandible of a user; acquiring a plurality of intersection points between each of a plurality of preset planes and the plurality of closing motion trajectories; determining the highest density point from the plurality of intersection points for each preset plane; and obtaining a muscular closure path by connecting the multiple highest density points corresponding to the plurality of the preset planes.

The present application claims the priority to Chinese patent application with application No. 202310969399.3, filed on Aug. 2, 2023, in China National Intellectual Property Administration, entitled “Data Processing Method, Apparatus, Device, and Medium” the content of which is hereby incorporated herein fully by reference into the present application for all purposes.

### TECHNICAL FIELD

The present application relates to a field of data processing technology, and specifically to a data processing method, an electronic device, and a storage medium.

### BACKGROUND

The muscular closure path plays an important role in determining dental occlusion relationships, determining tooth wear, and evaluating temporomandibular joint function.

In related technologies, methods for obtaining the muscular closure path are as follows: Solution 1: Obtaining the size of the muscular closure path through the finger method. In this method, fingers or special measuring instruments are used to measure the distance between the maxilla and mandible when the patient bites, thereby deriving the size of the muscular closure path. However, as the accuracy of measurement is influenced by the doctor's experience and skill level, errors may exist, resulting in an insufficiently accurate obtained muscular closure path. Furthermore, the finger method can only measure the size of the muscular closure path and cannot obtain information such as its shape. Solution 2: Obtaining the size of the muscular closure path through the occlusal film method. In this method, special pigment is applied to the surfaces of the maxillary and mandibular teeth, and the patient bites, with the wear degree of the pigment used to judge the size of the muscular closure path. However, the wear degree of the pigment may be affected by various factors such as the type of pigment and the patient's biting force, potentially leading to errors and insufficient accuracy of the obtained muscular closure path. Furthermore, the occlusal film method is similarly limited to measuring the magnitude of the muscular closure path and cannot obtain information such as its shape. Solution 3: Obtaining the muscular closure path through the electrical measurement method. In this method, special electrical measurement instruments are used to measure the resistance value between the maxilla and mandible when the patient bites, thereby measuring the muscular closure path. However, the electrical measurement method requires special equipment, has high operational difficulty, lacks simplicity in the operation process, and demands a high level of professional knowledge.

### SUMMARY

To solve the above technical problems, the present disclosure provides a data processing method, an electronic device, and a storage medium.

In a first aspect, an embodiment of the present disclosure provides a data processing method, including: acquiring a plurality of closing motion trajectories of a mandible of a user; acquiring a plurality of intersection points between each of a plurality of preset planes and the plurality of closing motion trajectories; determining the highest density point from the plurality of intersection points for each preset plane; obtaining a muscular closure path by connecting the multiple highest density points corresponding to the plurality of the preset planes.

In a second aspect, an embodiment of the present disclosure provides an electronic device, including: a storage device; at least one processor; and the storage device storing one or more programs that, when executed by the at least one processor, cause the at least one processor to: acquire a plurality of closing motion trajectories of a mandible of a user; acquire a plurality of intersection points between each of a plurality of preset planes and the plurality of closing motion trajectories; determine the highest density point from the plurality of intersection points for each preset plane; obtain a muscular closure path by connecting a plurality of highest density points corresponding to the plurality of the preset planes.

In a third aspect, an embodiment of the present disclosure provides a non-transitory storage medium having instructions stored thereon, when the instructions are executed by a processor of an electronic device, the processor is caused to perform a data processing method, wherein the method includes: acquiring a plurality of closing motion trajectories of a mandible of a user; acquiring a plurality of intersection points between each of a plurality of preset planes and the plurality of closing motion trajectories; determining the highest density point from the plurality of intersection points for each preset plane; obtaining a muscular closure path by connecting the multiple highest density points corresponding to the plurality of the preset planes.

### BRIEF DESCRIPTION OF THE DRAWINGS

The accompanying drawings, which are incorporated into and constitute a part of this specification, illustrate embodiments consistent with the present application and, together with the description, serve to explain the principles of the present application.

To describe the technical solutions in the embodiments of the present disclosure or in the prior art more clearly, the following briefly introduces the accompanying drawings required for describing the embodiments or the prior art. Obviously, the accompanying drawings in the following description show merely some embodiments of the present disclosure, and a person of ordinary skill in the art may still derive other drawings from these accompanying drawings without creative efforts.

FIG. 1 is a flowchart illustrating a data processing method according to an embodiment of the present disclosure.

FIG. 2 is a flowchart illustrating another data processing method according to an embodiment of the present disclosure.

FIG. 3 is a schematic diagram illustrating markers according to an embodiment of the present disclosure.

FIG. 4 is a structural diagram illustrating a data processing apparatus according to an embodiment of the present disclosure.

FIG. 5 is a schematic diagram of an electronic device in some embodiments of the present application.

### DETAILED DESCRIPTION

To make the objectives, technical solutions, and advantages of the present disclosure clearer, the solutions of the present disclosure will be further described below. It should be noted that the embodiments of the present disclosure and the features in the embodiments may be combined with each other without conflict.

Many specific details are set forth in the description below to facilitate a full understanding of the present disclosure. However, the present disclosure may also be implemented in other ways different from those described herein. Obviously, the embodiments in the specification are only a part of the embodiments of the present disclosure, not all of them.

FIG. 1 is a flowchart illustrating a data processing method according to an embodiment of the present disclosure. The method provided by this embodiment may be executed by a data processing apparatus, which may be implemented in software and/or hardware and integrated on any electronic device with computing capability.

As shown in FIG. 1, the data processing method provided by the embodiment of the present disclosure may include:

Step 101: multiple closing motion trajectories of a mandible of a user are acquired.

The method of this embodiment may be applied to obtain a user's muscular closure path.

In some embodiments of the present disclosure, relevant acquisition equipment is used to collect the mandibular motion trajectories during the user closing his mouth. For each closing process, one closing motion trajectory may be collected. N closing motion trajectories of the mandible of the user may be collected after the user closing his mouth for N times.

As an example, for a user's single mouth-opening and closing process, when the user opening the mouth and then closing the mouth, the mandible moves forward and upward along a direction of action of the jaw elevators. The motion trajectory of the user's mandible during this process may be collected. The motion trajectory includes an opening motion trajectory and a closing motion trajectory, which have different directions. Therefore, based on the direction of the motion trajectory, the opening motion trajectory is deleted, and the closing motion trajectory remained, thereby obtaining one closing motion trajectory of the mandible of the user.

Step 102: multiple intersection points between each of multiple preset planes and the multiple closing motion trajectories are acquired.

In some embodiments of the present disclosure, a coordinate system may be established based on user facial features, and multiple preset planes may be selected within the coordinate system. For example, multiple planes parallel to a alare-tragion line are selected as the preset planes.

The preset planes are used to cut the closing motion trajectories of the mandible. For each preset plane, each closing motion trajectory has one intersection point with that preset plane. Therefore, for n closing motion trajectories, each preset plane has n intersection points with the n closing motion trajectories. The intersection points may be represented by coordinates within the coordinate system.

Step 103: a highest density point from the multiple intersection points is determined for each preset plane.

In some embodiments of the present disclosure, for each preset plane, one highest density point may be determined. For example, for n closing motion trajectories of the mandible of the user, a plane has n intersection points with the n closing motion trajectories. The n intersection points are discrete points. The highest density point is determined from the n discrete points. Optionally, the highest density point among the multiple intersection points may be determined by a sum of distances between a certain intersection point and other intersection points.

The calculation process for the highest density point is explained below with an example.

As an example, determining the highest density point from the multiple intersection points includes: for each intersection point, determining distances from the intersection point to the other intersection points among the multiple intersection points; performing a weighted average of the distances from that intersection point to the other intersection points according to a Gaussian distribution function and obtaining a density metric value for the intersection point; then, respectively calculating the density metric values for the multiple intersection points; and determining the intersection point with the largest density metric value from the multiple intersection points as the highest density point.

In this example, for the n intersection points between a preset plane and the n closing motion trajectories, any one intersection point is denoted as p, and other intersection points among the n intersection points excluding point p are denoted as i. The distance from point p to other intersection points i is calculated, and the weighted average is performed according to the Gaussian distribution function to find the point with the smallest sum of distances, thereby determining the highest density point. The calculation formula for the density metric value of the point p is as follows:

$${D}_{p} = \frac{n}{{\sum }_{n}^{i} {‖ {C}_{i} - {C}_{p} ‖}_{2}^{σ}}$$

Where Dp represents the density metric value of point p, Cp represents the coordinates of point p, Ci represents the coordinates of point i, σ represents a parameter affecting the influence of point aggregation degree on the final result, with σ ranging from (0, 1], for example, σ=0.3.

It should be noted that the above formula is only one way to calculate the highest density point and is not specifically limited here.

Thus, for each preset plane, one highest density point is determined from the n intersection points. For M preset planes, M highest density points may be obtained.

Step 104: a muscular closure path is obtained by connecting the multiple highest density points corresponding to the multiple preset planes.

In some embodiments of the present disclosure, taking M preset planes as an example, the M highest density points are connected to obtain the muscular closure path. The muscular closure path may be used to determine dental occlusion relationships, determine tooth wear, evaluate temporomandibular joint function, etc.

According to the technical solution of this embodiment of the present disclosure, by acquiring multiple closing motion trajectories of the mandible of the user, acquiring multiple intersection points between each preset plane and the multiple closing motion trajectories, determining a highest density point from the multiple intersection points for each preset plane, and then connecting the multiple highest density points corresponding to the multiple preset planes to obtain the muscular closure path, it is possible to calculate the muscular closure path based on the motion trajectories of the mandible, thereby improving the accuracy of obtaining the muscular closure path. Furthermore, the operation process is simple, non-contact measurement is achieved, reducing discomfort for the measured user.

A specific implementation process is described below.

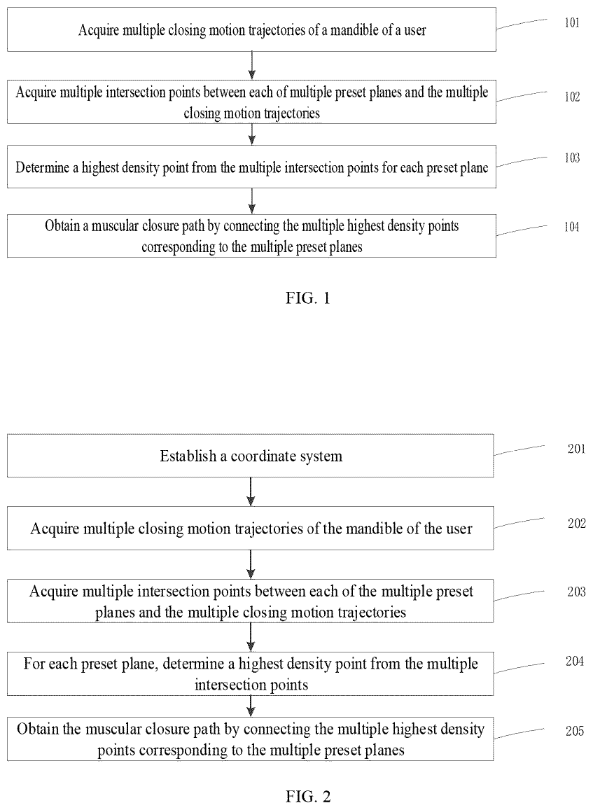

FIG. 2 is a flowchart illustrating another data processing method according to an embodiment of the present disclosure. As shown in FIG. 2, the method includes the following steps:

Step 201: a coordinate system is established.

In some embodiments of the present disclosure, the coordinate system is established as follows: Acquire facial data of the user, for example three-dimensional facial data, and based on the three-dimensional facial data, determine an intersection point of a midsagittal plane and the mandibular alveolar ridge crest line, an alar point, a tragion point, a left exocanthion point, and a right exocanthion point. Then, use the intersection point of the midsagittal plane and the mandibular alveolar ridge crest line as the coordinate origin O, use a line connecting the alar point and the tragion point as the X-axis, and use a line connecting the left exocanthion point and the right exocanthion point as the Z-axis to establish the coordinate system.

The midsagittal plane is a plane determined by a glabella point, a pronasale point, and a pogonion point. As an example, a scanner is used to obtain the user's three-dimensional facial data to determine the facial features such as the glabella point, the pronasale point, the pogonion point, the alar point, the tragion point, the left exocanthion point, and the right exocanthion point. Then, the line connecting the alar point and tragion point is used to determine the X-axis of the coordinate system, and the line connecting the left exocanthion point and right exocanthion point is used to determine the Z-axis of the coordinate system. The midsagittal plane is determined by the glabella point, the pronasale point, and the pogonion point. The intersection point of the midsagittal plane and the mandibular alveolar ridge crest line is used as the coordinate origin O. The Y-axis of the coordinate system is perpendicular to the XOZ plane.

In some embodiments of the present disclosure, the step for determining the multiple preset planes is as follows: In the Y-axis direction of the coordinate system, determine multiple planes parallel to the XOZ plane with preset intervals. Determine the XOZ plane and the multiple planes parallel to the XOZ plane as the multiple preset planes.

As an example, in the Y-axis direction, multiple planes are selected at intervals of 0.2 mm. These multiple planes are parallel to the XOZ plane, and the distance between every two adjacent planes is 0.2 mm. Thus, multiple preset planes including the XOZ plane are obtained. Through the above steps, the coordinate system is established and multiple preset planes are determined. The preset planes are used to cut the mandibular closing motion trajectories. Each preset plane generates n intersection points with the n closing motion trajectories of the mandible.

Step 202: multiple closing motion trajectories of the mandible of the user are acquired.

As an example, attach at least three markers to the user's teeth or gingiva. Position the user's mandible based on the at least three markers, generating a transformation relationship between the markers and the mandible. In this example, acquiring the multiple closing motion trajectories of the mandible of the user includes: capturing motion trajectories of the at least three markers during multiple closing motions using a scanner; generating the multiple closing motion trajectories of the user based on the transformation relationship and the motion trajectories of the at least three markers.

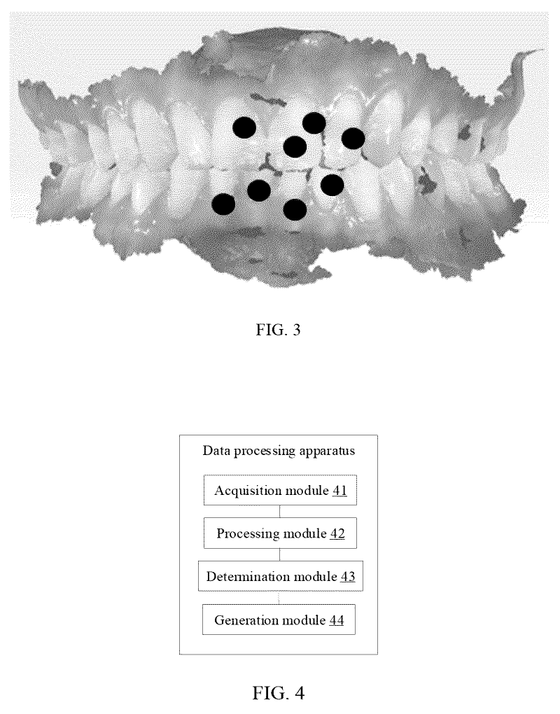

Referring to FIG. 3, FIG. 3 shows a schematic diagram of markers. As shown in FIG. 3, the upper dental arch has four markers attached, and the lower dental arch has four markers attached. Among them, the four markers on the same dental arch are not collinear. For the four markers on the lower dental arch, three-point positioning may be used to position the user's mandible by converting the positions of the markers into mandibular positional relationships. Then, during one closing motion, the scanner captures the motion trajectories of the markers. The motion trajectories of the markers represent the RT (rotation translation) data of the mandible relative to the maxilla, thereby obtaining the closing motion trajectory.

In some embodiments of the present disclosure, for the four markers on the upper dental arch, three-point positioning may be used to position the user's maxilla, to determine the intersection point of the midsagittal plane and the mandibular alveolar ridge crest line.

As another example, acquiring the multiple closing motion trajectories of the mandible user includes: extracting a mandibular alveolar ridge crest line and the midsagittal plane based on the facial data of the user; calculating an intersection point B of the mandibular alveolar ridge crest line and the midsagittal plane; then, acquiring motion trajectories of the intersection point B during multiple closing motions to obtain the multiple closing motion trajectories of the mandible of the user.

In this example, the motion trajectory of the mandible is collected through corresponding acquisition equipment to obtain the muscular closure path. Corresponding acquisition equipment includes, for example, a mandibular motion tracking system.

Step 203: multiple intersection points between each of the multiple preset planes and the multiple closing motion trajectories are acquired.

Step 204: For each preset plane, a highest density point from the multiple intersection points is determined.

Step 205: the muscular closure path is obtained by connecting the multiple highest density points corresponding to the multiple preset planes.

The explanations for steps 102 to 104 in the foregoing embodiments also apply to steps 203 to 205.

According to the technical solution of this embodiment of the present disclosure, by establishing the coordinate system based on the user's facial data, intersecting the closing motion trajectories with planes parallel to the XOZ plane at preset intervals in the Y direction, then determining the highest density points from the intersection points, and generating the muscular closure path by connecting the highest density points, the accuracy of obtaining the muscular closure path is improved, enabling complete acquisition of the muscular closure path, reducing reliance on professional knowledge. Moreover, the position of the mandible may be displayed in real-time based on the muscular closure path. The operation process is simple, non-contact measurement is achieved, reducing discomfort for the measured user.

FIG. 4 is a structural diagram illustrating a data processing apparatus according to an embodiment of the present disclosure. As shown in FIG. 4, the data processing apparatus includes: an acquisition module 41, a processing module 42, a determination module 43, and a generation module 44.

The acquisition module 41 is configured to acquire multiple closing motion trajectories of a mandible of a user.

The processing module 42 is configured to acquire multiple intersection points between each of a plurality of preset planes and the plurality of closing motion trajectories.

The determination module 43 is configured to determine a highest density point from the plurality of intersection points for each preset plane.

The generation module 44 is configured to obtain a muscular closure path by connecting the multiple highest density points corresponding to the plurality of the preset planes.

In some embodiments of the present disclosure, the data processing apparatus further includes: an establishment module, configured to acquire facial data of the user, and determine an intersection point of a midsagittal plane and a mandibular alveolar ridge crest line, an alare point, a tragion point, a left exocanthion point, and a right exocanthion point based on the facial data; establish a coordinate system by using the intersection point of the midsagittal plane and the mandibular alveolar ridge crest line as a coordinate origin O, using a line connecting the alare point and the tragion point as a X-axis, and using a line connecting the left exocanthion point and the right exocanthion point as a Z-axis; where the preset planes include an XOZ plane.

In some embodiments of the present disclosure, the data processing apparatus further includes: a selection module, configured to, in a Y-axis direction of the coordinate system, determining a plurality of planes parallel to the XOZ plane at preset intervals; wherein the Y-axis is perpendicular to the XOZ plane; determining the XOZ plane and the multiple planes parallel to the XOZ plane as the plurality of the preset planes.

In some embodiments of the present disclosure, the data processing apparatus further includes: a positioning module, configured to at least three markers to teeth or gingiva of the user; position the mandible of the user based on the at least three markers and generating a transformation relationship between the at least three markers and the mandible;

The acquisition module 41 is specifically configured to: capture motion trajectories of the at least three markers during the user closing mouth motion for a plurality of times using a scanner; generate the multiple closing motion trajectories of the mandible of the user based on the transformation relationship and the motion trajectories of the at least three markers.

In some embodiments of the present disclosure, the acquisition module 41 is specifically configured to: extract a mandibular alveolar ridge crest line and a midsagittal plane based on facial data of the user; calculate an intersection point B of the mandibular alveolar ridge crest line and the midsagittal plane; obtain the plurality of closing motion trajectories of the mandible of the user by acquiring motion trajectories of the intersection point B during the user closing mouth motion for a plurality of times.

In some embodiments of the present disclosure, the determination module 43 is specifically configured to: determine distances from each intersection point to other intersection points among the plurality of the intersection points; obtain a density metric value of each intersection point by performing a weighted average of the distances from each intersection point to other intersection points among the plurality of the intersection points; determine, from the multiple intersection points, the intersection point with the largest density metric value as the highest density point.

The data processing apparatus provided by the embodiments of the present disclosure can execute any data processing method provided by the embodiments of the present disclosure, and has corresponding functional modules and beneficial effects for executing the method. Details not fully described in the apparatus embodiments of the present disclosure may refer to the description in any method embodiment of the present disclosure.

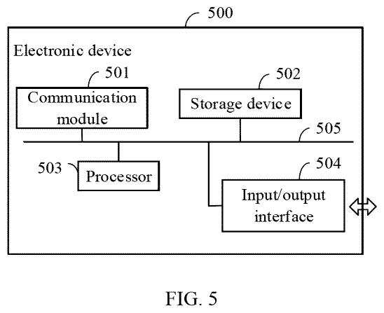

The present disclosure further provides an electronic device, as shown in FIG. 5. The electronic device 500 includes a communication module 501, a storage device 502, at least one processor 503, an input/output interface 504, and a bus 505. The at least one processor 503 is coupled or connected to the communication module 501, the storage device 502, and the input/output interface 504 via the bus 505 respectively.

The communication module 501 may be a wireless communication module or a mobile communication module. The wireless communication module may provide a wireless communication solution applied to the electronic device 500 including a wireless local area network (WLAN) (e.g., Wireless Fidelity (Wi-Fi) network), Bluetooth (BT), a Global Navigation Satellite System (GNSS), a Frequency Modulation (FM), a Near Field Communication (NFC), an Infrared (IR) technology, etc. The mobile communication module may provide mobile communication solutions applied to the electronic device 500 including 2G/3G/4G/5G or subsequent evolving mobile communication technologies.

The storage device 502 may include one or more random access memories (RAM) and one or more non-volatile memories (NVM). The random access memory may be directly read from and written to by the at least one processor 503, and may be used to store executable programs (e.g., machine instructions) for the operating system or other running programs, and can also be used to store user and application data, etc. The random access memory may include static random-access memory (SRAM), dynamic random-access memory (DRAM), synchronous dynamic random-access memory (SDRAM), double data rate synchronous dynamic random-access memory (DDR SDRAM, e.g., the fifth generation DDR SDRAM generally called DDR5 SDRAM), etc.

The non-volatile memory may also store executable programs and user and application data, etc., which may be pre-loaded into the random access memory for direct reading and writing by the at least one processor 503. The non-volatile memory may include a disk storage device, a flash memory.

The storage device 502 is for storing one or more computer programs. The one or more computer programs are configured to be executed by the at least one processor 503. The one or more computer programs include a plurality of instructions, which, when executed by the at least one processor 503, implement the audio playing method executable on the electronic device 500.

In other embodiments, the electronic device 500 further includes an external memory interface for connecting to external memory to expand the storage capacity of the electronic device 500.

The at least one processor 503 may include one or more processing units, for example: the at least one processor 503 may include an application processor (AP), a modem processor, a graphics processing unit (GPU), an image signal processor (ISP), a controller, a video codec, a digital signal processor (DSP), a baseband processor, and/or a neural-network processing unit (NPU), etc. Different processing units may be independent devices or integrated into one or more processors.

The at least one processor 503 provides computing and control capabilities, for example, the at least one processor 503 is for executing computer programs stored in the storage device 502 to implement the aforementioned audio playing method.

The input/output interface 504 is for providing channels for user input or output, for example, the input/output interface 504 may be used to connect various input/output devices, such as a mouse, a keyboard, a touch device, a display screen, etc., allowing users to input information or make information visual.

The bus 505 is at least for providing communication channels between the communication module 501, the storage device 502, the processor 503, and the input/output interface 504 within the electronic device 500.

It should be understood that the structure illustrated in the embodiments of the present application does not constitute a specific limitation on the electronic device 500. In other embodiments of the present application, the electronic device 500 may include more or fewer components than illustrated, or combine some components, or split some components, or arrange components differently. The illustrated components may be implemented in hardware, software, or a combination of software and hardware.

In addition, depending on the specific application, the electronic device may also include any other appropriate components such as a bus, input/output interfaces, etc.

In addition to the above methods and apparatus, embodiments of the present disclosure may also be a computer program product comprising computer program instructions. When the computer program instructions are executed by a processor, the processor is caused to perform any method provided by the embodiments of the present disclosure.

The computer program product may be written in any combination of one or more programming languages for executing the operations of the embodiments of the present disclosure. Programming languages include object-oriented programming languages such as Java, C++, etc., and conventional procedural programming languages such as the “C” language or similar programming languages. The program code may execute entirely on the user's computing device, partly on the user's device, as a stand-alone software package, partly on the user's computing device and partly on a remote computing device, or entirely on a remote computing device or server.

Furthermore, embodiments of the present disclosure may also be a computer-readable storage medium having computer program instructions stored thereon. When the computer program instructions are executed by a processor, the processor is caused to perform any method provided by the embodiments of the present disclosure.

The computer-readable storage medium may include any combination of one or more readable media. The readable medium may be a readable signal medium or a readable storage medium. The readable storage medium may include, for example, but is not limited to, electrical, magnetic, optical, electromagnetic, infrared, or semiconductor systems, apparatuses, or devices, or any suitable combination of the foregoing. More specific examples (a non-exhaustive list) of the readable storage medium include: electrical connections having one or more wires, portable disks, hard disks, random access memory (RAM), read-only memory (ROM), erasable programmable read-only memory (EPROM or flash memory), optical fiber, portable compact disk read-only memory (CD-ROM), optical storage devices, magnetic storage devices, or any suitable combination of the foregoing.

It should be noted that terms such as “first” and “second” are used herein only to distinguish one entity or operation from another entity or operation, and do not necessarily require or imply any actual such relationship or order between these entities or operations. Furthermore, the terms “comprises”, “comprising”, or any other variation thereof are intended to cover a non-exclusive inclusion, such that a process, method, article, or device that includes a list of elements includes not only those elements but may also include other elements not expressly listed or inherent to such process, method, article, or device. Without more constraints, an element defined by the phrase “comprising a . . . ” does not preclude the existence of additional identical elements in the process, method, article, or device that includes the element.

The above description is only specific embodiments of the present disclosure to enable those skilled in the art to understand or implement the present disclosure. Various modifications to these embodiments will be readily apparent to those skilled in the art, and the general principles defined herein may be implemented in other embodiments without departing from the spirit or scope of the present disclosure. Therefore, the present disclosure is not limited to the embodiments described herein but is to be accorded the widest scope consistent with the principles and novel features disclosed herein.

### INDUSTRIAL APPLICABILITY

The technical method provided in this disclosure may be applied to the field of data processing technology. In the embodiments of this disclosure, multiple closing motion trajectories of a mandible of a user are acquired, multiple intersection points between each of a plurality of preset planes and the plurality of closing motion trajectories are obtained, and for each preset plane, a highest density point from the plurality of intersection points is determined. Subsequently, the highest density points corresponding to the multiple preset planes are connected to generate the muscular closure path. As a result, the muscular closure path may be calculated based on the motion trajectories, thereby improving the accuracy of muscular closure path acquisition. Furthermore, the operational process is simple, eliminates the need for contact-based measurement, and reduces discomfort for the subject.

What is claimed is:

1. A data processing method, comprising:
acquiring a plurality of closing motion trajectories of a mandible of a user;
acquiring a plurality of intersection points between each of a plurality of preset planes and the plurality of closing motion trajectories;
determining the highest density point from the plurality of intersection points for each preset plane;
obtaining a muscular closure path by connecting a plurality of highest density points corresponding to the plurality of the preset planes.

2. The method according to claim 1, wherein before acquiring the plurality of intersection points between each of the plurality of preset planes and the plurality of closing motion trajectories, the method further comprises:
acquiring facial data of the user, and determining an intersection point of a midsagittal plane and a mandibular alveolar ridge crest line, an alare point, a tragion point, a left exocanthion point, and a right exocanthion point based on the facial data;
establishing a coordinate system by using the intersection point of the midsagittal plane and the mandibular alveolar ridge crest line as a coordinate origin O, using a line connecting the alare point and the tragion point as an X-axis, and using a line connecting the left exocanthion point and the right exocanthion point as a Z-axis; wherein the preset planes comprise an XOZ plane.

3. The method according to claim 2, wherein after establishing the coordinate system, the method further comprises:
in a Y-axis direction of the coordinate system, determining a plurality of planes parallel to the XOZ plane at preset intervals; wherein the Y-axis is perpendicular to the XOZ plane;
determining the XOZ plane and the plurality of planes parallel to the XOZ plane as the plurality of the preset planes.

4. The method according to claim 1, further comprising:
attaching at least three markers to teeth or gingiva of the user;
positioning the mandible of the user based on the at least three markers and generating a transformation relationship between the at least three markers and the mandible;
wherein acquiring the plurality of the closing motion trajectories of the mandible of the user comprises:
capturing motion trajectories of the at least three markers during the user closing mouth motion for a plurality of times using a scanner;
generating the plurality of closing motion trajectories of the mandible of the user based on the transformation relationship and the motion trajectories of the at least three markers.

5. The method according to claim 1, wherein the acquiring the plurality of closing motion trajectories of the mandible of the user comprises:
extracting a mandibular alveolar ridge crest line and a midsagittal plane based on facial data of the user;
calculating an intersection point B of the mandibular alveolar ridge crest line and the midsagittal plane;
obtaining the plurality of closing motion trajectories of the mandible of the user by acquiring motion trajectories of the intersection point B during the user closing mouth motion for a plurality of times.

6. The method according to claim 1, wherein determining the highest density point from the plurality of intersection points comprises:
determining distances from each intersection point to other intersection points among the plurality of the intersection points;
obtaining a density metric value of each intersection point by performing a weighted average of the distances from each intersection point to other intersection points among the plurality of the intersection points;
determining, from the plurality of the intersection points, the intersection point with the largest density metric value as the highest density point.

7. The method according to claim 4, wherein the closing motion trajectory is determined by:
capturing the mouth-opening and closing processes of the user to generate a mandibular motion trajectory;
obtaining the closing motion trajectory from the mandibular motion trajectory based on the direction of the mandibular motion trajectory.

8. The method according to claim 4, wherein the at least three markers are arranged in a non-collinear configuration and are disposed on the lower dental arch of the user.

9. An electronic device, comprising:
a storage device;
at least one processor; and
the storage device storing one or more programs that, when executed by the at least one processor, cause the at least one processor to:
acquire a plurality of closing motion trajectories of a mandible of a user;
acquire a plurality of intersection points between each of a plurality of preset planes and the plurality of closing motion trajectories;
determine the highest density point from the plurality of intersection points for each preset plane;
obtain a muscular closure path by connecting a plurality of highest density points corresponding to the plurality of the preset planes.

10. The electronic device according to claim 9, wherein before the at least one processor acquires the plurality of intersection points between each of the plurality of preset planes and the plurality of closing motion trajectories, the processor is further caused to:
acquire facial data of the user, and determining an intersection point of a midsagittal plane and a mandibular alveolar ridge crest line, an alare point, a tragion point, a left exocanthion point, and a right exocanthion point based on the facial data;
establish a coordinate system by using the intersection point of the midsagittal plane and the mandibular alveolar ridge crest line as a coordinate origin O, use a line connecting the alare point and the tragion point as an X-axis, and use a line connecting the left exocanthion point and the right exocanthion point as a Z-axis; wherein the preset planes comprise an XOZ plane.

11. The electronic device according to claim 10, wherein after the at least one processor establishes the coordinate system, the processor is further caused to:
in a Y-axis direction of the coordinate system, determine a plurality of planes parallel to the XOZ plane at preset intervals; wherein the Y-axis is perpendicular to the XOZ plane;
determine the XOZ plane and the plurality of planes parallel to the XOZ plane as the plurality of the preset planes.

12. The electronic device according to claim 9, wherein the at least one processor is further caused to:
attach at least three markers to teeth or gingiva of the user;
position the mandible of the user based on the at least three markers and generate a transformation relationship between the at least three markers and the mandible;
wherein the processor acquires the plurality of the closing motion trajectories of the mandible of the user by:
capturing motion trajectories of the at least three markers during the user closing mouth motion for a plurality of times using a scanner;
generating the plurality of closing motion trajectories of the mandible of the user based on the transformation relationship and the motion trajectories of the at least three markers.

13. The electronic device according to claim 9, wherein the at least one processor acquires the plurality of closing motion trajectories of the mandible of the user by:
extracting a mandibular alveolar crest line and a midsagittal plane based on facial data of the user;
calculating an intersection point B of the mandibular alveolar ridge crest line and the midsagittal plane;
obtaining the plurality of closing motion trajectories of the mandible of the user by acquiring motion trajectories of the intersection point B during the user closing mouth motion for a plurality of times.

14. The electronic device according to claim 9, wherein the at least one processor determines the highest density point from the plurality of intersection points by:
determining distances from each intersection point to other intersection points among the plurality of the intersection points;
obtaining a density metric value of each intersection point by performing a weighted average of the distances from each intersection point to other intersection points among the plurality of the intersection points;
determining, from the plurality of the intersection points, the intersection point with the largest density metric value as the highest density point.

15. The electronic device according to claim 12, wherein the at least one processor determines the closing motion trajectory by:
capturing the mouth-opening and closing processes of the user to generate a mandibular motion trajectory;
obtaining the closing motion trajectory from the mandibular motion trajectory based on the direction of the mandibular motion trajectory.

16. The electronic device according to claim 12, wherein the at least three markers are arranged in a non-collinear configuration and are disposed on the lower dental arch of the user.

17. A non-transitory storage medium having at least one instruction stored thereon, when the at least one instruction is executed by a processor of an electronic device, the processor is caused to perform a data processing method, wherein the method comprises:
acquiring a plurality of closing motion trajectories of a mandible of a user;
acquiring a plurality of intersection points between each of a plurality of preset planes and the plurality of closing motion trajectories;
determining the highest density point from the plurality of intersection points for each preset plane;
obtaining a muscular closure path by connecting a plurality of highest density points corresponding to the plurality of the preset planes.

18. The non-transitory storage medium according to claim 17, wherein before acquiring the plurality of intersection points between each of the plurality of preset planes and the plurality of closing motion trajectories, the method further comprises:
acquiring facial data of the user, and determining an intersection point of a midsagittal plane and a mandibular alveolar ridge crest line, an alare point, a tragion point, a left exocanthion point, and a right exocanthion point based on the facial data;
establishing a coordinate system by using the intersection point of the midsagittal plane and the mandibular alveolar ridge crest line as a coordinate origin O, using a line connecting the alare point and the tragion point as a X-axis, and using a line connecting the left exocanthion point and the right exocanthion point as a Z-axis; wherein the preset planes comprise an XOZ plane.

19. The non-transitory storage medium according to claim 17, wherein the method further comprises:
attaching at least three markers to teeth or gingiva of the user;
positioning the mandible of the user based on the at least three markers and generating a transformation relationship between the at least three markers and the mandible;
wherein acquiring the plurality of the closing motion trajectories of the mandible of the user comprises:
capturing motion trajectories of the at least three markers during the user closing mouth motion for a plurality of times using a scanner;
generating the plurality of closing motion trajectories of the mandible of the user based on the transformation relationship and the motion trajectories of the at least three markers.

20. The non-transitory storage medium according to claim 17, wherein the acquiring the plurality of closing motion trajectories of the mandible of the user comprises:
extracting a mandibular alveolar ridge crest line and a midsagittal plane based on facial data of the user;
calculating an intersection point B of the maxillary ridge crest line and the midsagittal plane;
obtaining the plurality of closing motion trajectories of the mandible of the user by acquiring motion trajectories of the intersection point B during the user closing mouth motion for a plurality of times.
